(19) United States
(12) Patent Application Publication
(10) Pub. No.: US 2024/0345456 A1
(43) Pub. Date: Oct. 17, 2024

(54) Uniform Camera-Lighting System

(71) Applicant: Tour It Now Inc., Temecula, CA (US)

(72) Inventor: Carlos F. Hernandez, Temecula, CA (US)

(21) Appl. No.: 18/617,087

(22) Filed: Mar. 26, 2024

Related U.S. Application Data
(60) Provisional application No. 63/492,454, filed on Mar. 27, 2023.

(51) Int. Cl. G03B 15/02; G03B 17/55; H04N 23/74

(52) U.S. Cl. CPC G03B 15/02; G03B 17/55; H04N 23/74

(57) ABSTRACT

Various embodiments of a method and apparatus for lighting a region of interest are disclosed. The region of interest is an image capture region, which is a region that the camera captures in an image. Strips of light are placed in a trough. The trough has four sections that are joined together to form a rectangle that is mounted on a camera, surrounding the camera, placing the strips of light surrounding the camera and therefore surrounding the lens. In some embodiments, the strips of light are mounted to point 44 degrees outward from the direction that the camera points. In some embodiments, each portion of the trough has two parallel strips of lights.

### CROSS-REFERENCE TO RELATED APPLICATIONS—CLAIM OF PRIORITY

The present application claims priority to U.S. Provisional Application No. 63/492,454, filed Mar. 27, 2023, entitled “Uniform Camera-Lighting System”, which is herein incorporated by reference in its entirety.

### BACKGROUND

### (1) Technical Field

The disclosed method and apparatus relate generally to systems for lighting a region of interest while taking a picture. In particular, the disclosed method and apparatus relate to uniformly (or evenly) lighting the region of interest.

### (2) Background

It is known that multiple images can be pieced together to form a panoramic view or a digital twin (a virtual replica of an object or region). When recording damage to a facility, a series of images of the interior are taken, which can be pieced together to form a panoramic image. The images are used to assess the damage. Often special cameras are used that incorporate LIDAR (Laser Imaging, Detection and Ranging) or laser scanning camera, and the camera captures, and stores, distance information related to the area being photographed and the features of the area, which is incorporated into a photographic three-dimensional model of the area. This type of camera has a unique geometry and lighting requirements. An example of such a camera is sold under the tradename of MatterPort PRO3 (which is available through Matterport having headquarters at 352 East Java Drive Sunnyvale, CA 94089, www.materport.com). Currently, no lighting system exists for these cameras. It is desirable to be able to capture an accurate panorama view of a room with relatively few image captures (e.g., 4), while illuminating the room uniformly and keeping the power consumption low. However, a fire-damaged or water-damaged room may not have its own lighting and may not have electricity. Although one could illuminate the room with high-power conventional camera lighting systems, conventional lighting systems require significant additional time to set up the lights, which require an additional power source requiring a relatively significant amount of additional power.

FIG. 1 illustrates a room lit with the room's lighting system. FIG. 1 is provided so that the lighting provided by the camera's lighting system can be compared with that of ordinary lighting of a room. FIG. 2 illustrates an image in which the lighting is provided by attaching a light (i.e., a flashlight) to the top of a camera, with the light pointing forward. The result is ununiform (or uneven) lighting of the area of interest. Note that in FIG. 2, there are large shadow regions surrounding the well-illuminated area, which is relatively small. Joining together the well-lit regions of multiple images to form a panoramic image would require an enormous number of images. The process of taking and combining the images would also be onerous. FIG. 3 illustrates an image taken with the same light as used for FIG. 2 but having the light pointing toward the ceiling. The area of interest is more uniformly lit than when pointing the light forwards, but the lighting is poor, and the image is mostly shadows.

Accordingly, it would be advantageous to provide a system that can capture images of an area of interest while reducing the shadowy regions of the image.

### SUMMARY

Various embodiments of a method and apparatus for uniformly lighting a region of interest are disclosed.

Lights (which in some embodiments are Light Emitting Diode (LED) lights) are arranged around the camera's lens system and mounted in a structure that attaches to the camera. In some embodiments, the lighting is provided by lights arranged in a rectangle or square arranged around the camera's lens system. In some embodiments, the lights are placed in a hood that is shaped like a trough that fits onto the camera body and has an opening, which when the trough is mounted on the camera, faces the same direction as the lens system. The trough directs the light out of the opening.

One example of the environment in which the lighting system can be deployed is a camera having a laser for measuring the distance within the region being photographed so that a 3D image can be constructed. In some embodiments, the lights are mounted on a hood that is attached to the camera.

In some embodiments, the lights are angled outwards, to uniformly light the edge region of the panoramic panel, keeping the edge well-lit, to reduce the formation of shadows. For example, if the camera takes images at 90-degree intervals, in some embodiments, the uniformly lit region should cover an angle that is noticeably greater than 90 degrees (e.g., 100 degrees).

In some embodiments, two strips of lights, oriented vertically, are placed on the sides of the camera—one strip on each side of the lens—each strip pointing 44 degrees (or 5% to 10% more) outwards away from the direction that the camera points, so that the angle between the direction of the two strips of lights is 88 degrees (or 5% to 10% more). In some embodiments, a second set of strips of lights, oriented vertically, are placed on each side of the camera pointing 22 degrees (or 5% to 10% more) outwards, so that there are 44 degrees between the directions of two strips of light. Thus, in this embodiment, there would be four strips of lights on the sides of the camera (two strips on each side).

In some embodiments, another pair of light strips, oriented horizontally, are placed around the camera—one strip on top of the camera and one strip on the bottom of the camera. The two strips are oriented pointing 60 degrees outwards away from the direction that the camera is pointing. Thus, in this embodiment, the horizontal lights are oriented to point 120 degrees apart (or 5% to 10% more). In some embodiments, there are four horizontal strips of lights, two on top of the lens and two below the lens. Two of the four horizontal strips of lights (one above the lens and one above the lens) face forwards parallel to the direction that the camera points. In some embodiments, the horizontal strips of lights draw 5 watts. Two of the four horizontal strips of lights (one above the lens and one below the lens) face 60 degrees outwards away from the direction that the camera points. In some embodiments, the horizontal lights pointing straight ahead are LEDs that draw 10 watts, and the lights pointing at 60 degrees are 5-watt LEDs. In some embodiments, the two horizontal strips that face forwards are closer to the lens than the two horizontal strips that face outwards. In some embodiments, the two horizontal strips that face are closer to the lens than the two horizontal strips that face outwards.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 illustrates an image of a room illuminated with the lights of the room.

FIG. 2 illustrates an image of the same room illuminated with a prior art light pointing forward.

FIG. 3 illustrates an image of the same room illuminated with a prior art light pointed toward the ceiling.

FIG. 4 illustrates an image of a front of a camera according to some embodiments a lighting system having a hood in which lights are mounted for uniformly illuminating a region of interest.

FIG. 5 illustrates an image of a side of a camera according to some embodiments in which lights are mounted in the hood of FIG. 4 for uniformly illuminating a region of interest.

FIG. 6 illustrates an exploded view of some embodiments of the lighting system of FIG. 4.

FIG. 7A illustrates a perspective view, FIG. 7B illustrates a right-side view, FIG. 7C illustrates a top view, FIG. 7D illustrates a front view, FIG. 7E illustrates a bottom view and FIG. 7F is a left-side view of some embodiments of the hood.

FIG. 8A illustrates a diagram showing an example of an angle characterizing a region that is uniformly lit by some embodiments of the lighting system.

FIGS. 8B-8E illustrate some embodiments of the angles at which the lights of FIG. 8A are oriented with respect to the direction that the camera is pointed.

FIG. 9 illustrates a flowchart according to some embodiments of a method of operating the lighting system.

FIG. 10 illustrates an image of the same room as FIGS. 1-3, illuminated with the lighting system, according to some embodiments, having the lights facing angled at 44 degrees outwards.

FIG. 11 illustrates the shadows that are formed at the meeting of the images produced by the embodiments of FIG. 10.

FIG. 12 illustrates an image of the same room illuminated, according to some embodiments of the hood of FIG. 10, except that the lighting system has additional lights that were not used for capturing the image of FIG. 10.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

A system and method are disclosed that provides uniform lighting for a camera, which in some embodiments has a LIDAR system built in. The region of interest includes a region that is greater in size than an image capture region. In some embodiments, the uniform lighting is provided for a region that is greater in size than the image capture region. Consequently, when images are combined to form a combined image. The combined image has fewer shadows than would otherwise appear in the combined image.

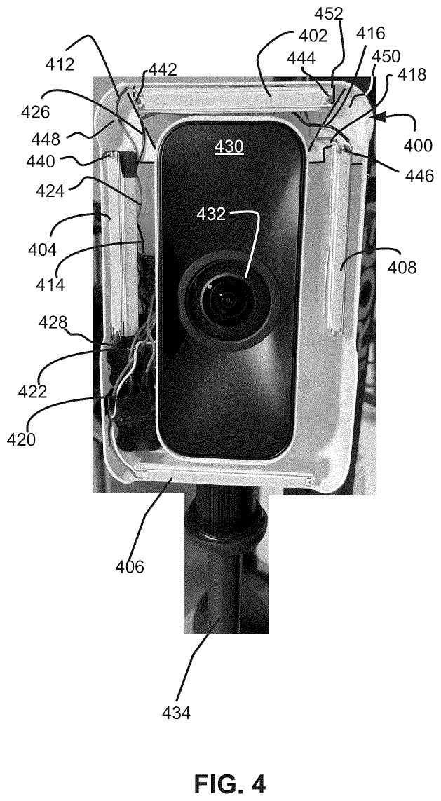

FIG. 4 is an image of a front of a hood 400 in which lights are mounted for uniformly illuminating a region of interest. FIG. 4 illustrates a hood 400 with lights 402, 404, 406 and 408, wires 412, 414, 416, 418, 420, 422, 424 and 426, a battery pack 428, a camera 430, a lens system 432, a column 434, fasteners 442, 444 and 446, and tabs 448, 450 and 452.

In some embodiments, the lights 402, 404, 406 and 408 (a plurality of lights) face forwards. In some embodiments, the lights 402, 404, 406 and 408 are angled outwards away from the direction in which the camera 430 faces. The lights 402, 404, 406 and 408 are angled to evenly illuminate a portion of a region of interest that is being photographed. The portion of the region of interest currently being captured by the camera is the image-capture-region. The lens system 432 of the camera 430 is focused so that the image-capture-region is captured in an image on a media (a photographic film or machine memory). Although the image captured includes the image-capture-region and, in some embodiments, only a portion of the image captured in a combined image (the combined image forms a panoramic image).

In some embodiments, the lights 402, 404, 406 and 408 are mounted in the hood 400 and receive electricity, via wires 412, 414, 416, 418, 420, 422, 424 and 426 from the battery pack 428 causing the lights to illuminate the region of interest. The hood 400 is fitted on the camera 430. In some embodiments, the camera 430 is equipped with LIDAR and is configured for capturing images and spatial information of an interior of an apartment, house or building and constructing a three-dimensional pictorial model of the interior of the structure. The camera 430 includes the lens system 432 and sits on the column 434. The column 434 is the center column of a tripod. In some embodiments, the lights 402, 404, 406 and 408 are LEDs (Light Emitting Diodes). In some embodiments, the lights 402, 404, 406 and 408 are mounted on structures (i.e., tabs) that protrude from the hood 400. In some embodiments, the angles at which the lights 402, 404, 406 and 408 are mounted are adjustable.

In some embodiments, the hood 400 hugs the camera 430 on the sides of the camera 430 surrounding the lens system 432. In some embodiments, the hood 400 is held on the camera 430 by an adhesive. In some embodiments, the hood 400 is held on the camera 430 by a friction fit.

The fasteners 442, 444 and 446 fasten lights 402, 404 and 406 to tabs 448, 452 and 450, respectively. In some embodiments, the fasteners 442, 444 and 446 are screws. The tabs 448, 452 and 450 are spaced partway between the front of the hood 400 and the back of the hood 400, parallel to the front of the hood 400, to hold the lights 402, 404 and 406 angled with respect to the front of the hood 400 (lights 402 and 406 are oriented horizontally and lights 404 and 408 are oriented vertically). In other embodiments, lights 402, 404 and 406 are fastened to the walls of the hood 400. In the embodiments of FIG. 4, the light 408 is adhered to a bottom outer wall of the hood 400. In other embodiments, there may be one or more tabs similar to the tabs 448, 450 and 452 to which the light 408 is fastened.

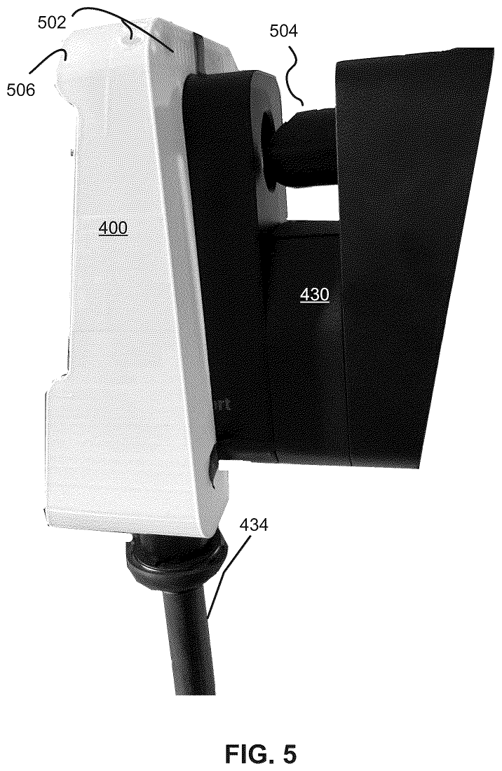

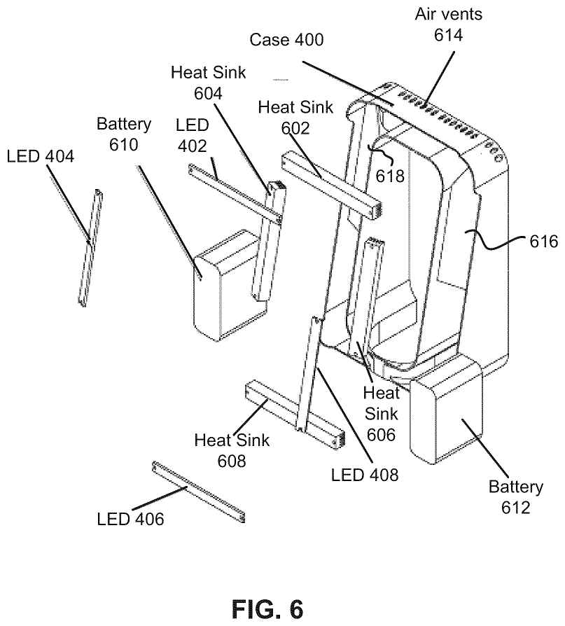

FIG. 5 is an image of a side of the camera 430 with the hood 400 attached. The hood 400 includes air vents 502 for cooling the lights and the camera 430 includes a laser scanner 504 for measuring the distances between features of a structure (i.e., the inside of a building). FIGS. 4 and 5 show how the hood 400 is mounted on the camera 430. In some embodiments, the hood 400 does not cover the laser scanner 504 and does not extend beyond a front of the camera 430 to allow for a wide angle of view, except at the top of hood 400. In some embodiments, the bottom of the hood 400 is wider than the top. In some embodiments, the front of the camera 430 has a sloped face, so the hood 400 also follows the profile of the camera 430 to ensure the hood 400 does not protrude into the field of view of the camera's lens system 432, to avoid narrowing the field of view of camera 430. The width of the bottom of the hood 400 facilitates storing the battery 428 (or the battery packs 610 and 612, see FIG. 6, which is discussed below). In some embodiments, the top of the hood 400 is too narrow to hold the batteries. In some embodiments, hood 400 includes a glare visor 506 for reducing glare. The glare visor 506 is a top portion of the hood 400 that protrudes forwards beyond the front of the camera 430. The hood 400 surrounds the lens system 432 (as a result of surrounding the body of camera 430). In some embodiments, the hood 400 is held on the camera 430 by an adhesive. In some embodiments, the hood 400 is held on the camera 430 by a friction fit.

FIG. 6 is an exploded view of the hood 400. In the embodiment of FIG. 6, the lights 402-408 are backed by heat sinks 602-608, for cooling lights 402-408, respectively. In the embodiments of FIG. 6, there are two battery packs 610 and 612 (as opposed to one in contrast to the embodiment of FIG. 4). In the embodiments of FIG. 6, the hood 400 includes air vents 614 for cooling the lights 402-408. In some embodiments, a fan is also included to cool the lights 402-408. The embodiment of FIG. 6 includes supports 616 and 618 are tabs that support the lights 404 and 408.

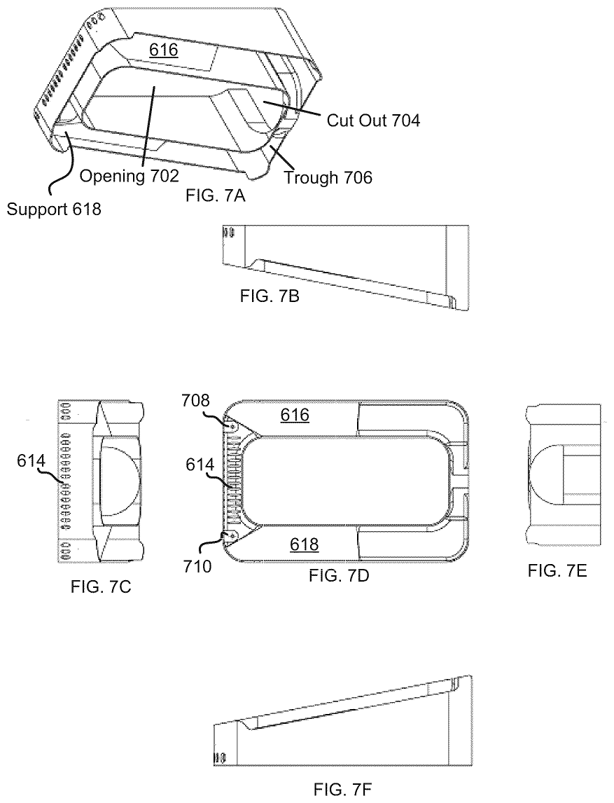

FIG. 7A is a perspective view, FIG. 7B is a right-side view, FIG. 7C is a top view, FIG. 7D is a front view, FIG. 7E is a bottom view, and FIG. 7F is a left-side view of the hood 400. In some embodiments, the opening 720 is rectangular, because the camera 430 has a rectangular cross-section. In some embodiments, the cut-out 704 is semicircular because the column 434 has a circular cross-section. FIG. 7A illustrates a trough 706, prior to mounting the lights 402, 404, 406 and 408, the wires 412, 414, 416, 418, 420, 422, 424 and 426 and the battery pack 428 or battery packs 610 and 612. Trough 706 is formed by the interior of the hood 400.

In some embodiments, the cut-out 704 is semicircular, because the column 434 has a circular cross-section. A trough 706 is formed from the interior of the hood 400 before mounting the lights 402, 404, 406 and 408, the wires 412, 414, 416, 418, 420, 422, 424 and 426 and the battery pack 428 or battery packs 602 and 604. In some embodiments, fasteners 708 and 710 fasten the lights 402 to the hood 400. In some embodiments, the fasteners 708 and 710 are screw holes (which mate with fasteners 442 and 444).

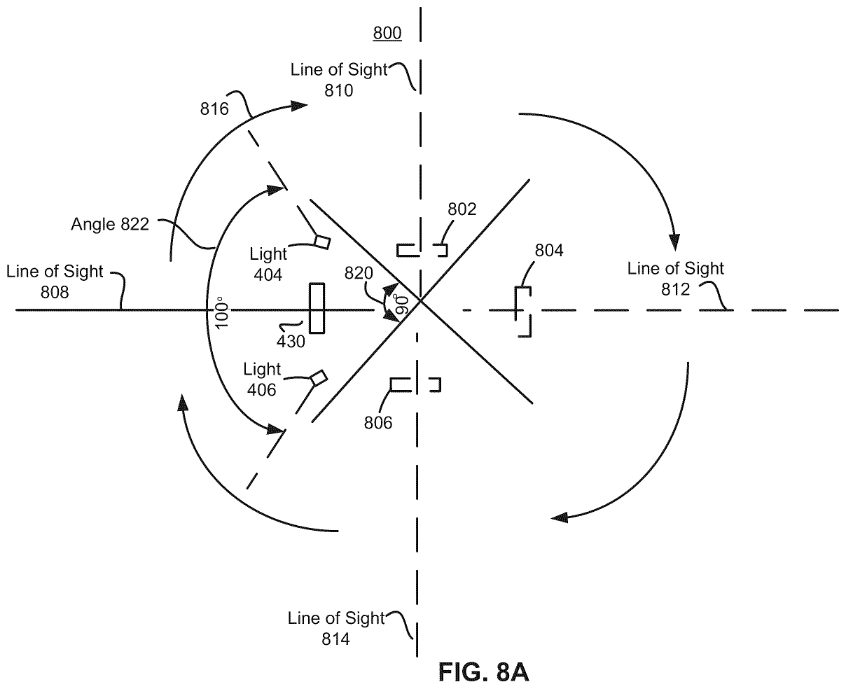

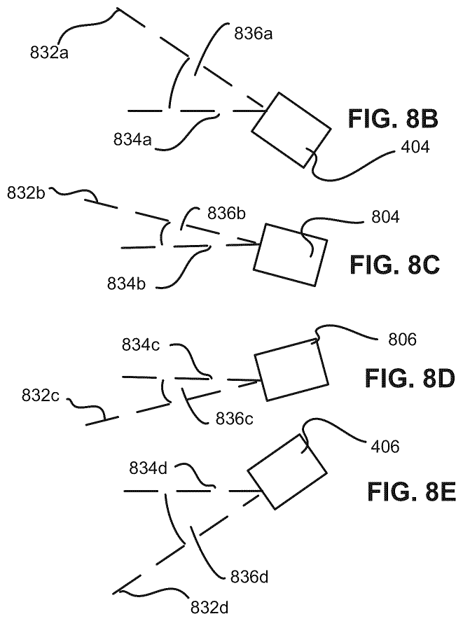

FIG. 8A is a diagram 800 illustrating an example of the angle that is uniformly lit by the hood 400. The diagram 800 illustrates lights 404 and 408, lens system 422, lens systems 802, 804 and 806, lines of sight 808, 810, 812 and 814, direction of rotation 816 and angles 820 and 822. The lines of sight 808, 810, 812 and 814 are the directions in which the lens systems 422, 802, 804 and 806, respectively, are pointing. The line of sight 808 is the direction that the lens system 422 is currently pointed and is the direction in which the camera 430 is pointed while capturing an image. The direction of rotation 816 is the direction (in this example) that the camera 430 is rotated while taking pictures (the camera 430 could be rotated in the opposite direction instead of the direction illustrated in FIG. 8A). The line of sight 810 is the second direction that the camera 430 points while taking an image. The line of sight 812 is the third direction that the camera 430 points while taking an image. The line of sight 814 is the fourth direction that the camera 430 points while taking an image. The lens systems 802, 804 and 806 and the lines of sight 810, 812 and 814 are drawn in phantom to distinguish between the current direction of the camera 430 and the other directions that the camera 430 will be pointed to capture the other images.

In the example of FIG. 8A, the different lines of sight are 90 degrees apart. Accordingly, the angle that is desired for each image to cover is greater than 90 degrees, as illustrated by the angle 820 (for the current direction of the camera), whereas the image capture region is 90 degrees wide). To reduce or avoid the shadows in the regions at which the images are joined together, the angle that needs to be uniformly illuminated is significantly wider (e.g., 5% to 15% or 10% wider) than that angle between the lines of sight or the angle characterizing the image-capture region. In the example of FIG. 4, the angle of the region that is uniformly illuminated is 100 degrees and the lights 404 and 408 are angled outward to achieve the uniform illumination. Similarly, in some embodiments, the lights 404 and 408 are angled outwards (upward and downward, respectively), to achieve the uniform illumination while imaging the ceiling and floor. In some embodiments, if the lines of sight are 60 degrees apart, the lights are angled to uniformly illuminate an image-capture-region characterized by an angle of 65 degrees. In another embodiment, the lights 404 and 408 are angled to be 22 degrees from the line of sight, as discussed in more detail regarding FIGS. 8B and 8C, below.

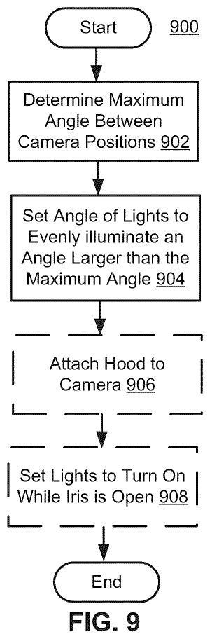

FIGS. 8B-8E illustrates the angles at which the lights 404 and 406 of FIG. 9A and optional lights 804 and 806 are oriented. In FIGS. 8A-E lines 832a-e, respectively, illustrate the direction that the camera is pointed. Lines 834a, 834d, 834b, and 834c illustrate the direction that the lights 404, 406, 804, and 806, respectively, are pointed. Angles 836a-d are the angles between the direction in which the camera 430 is pointed (as indicated by the lines 832a-d) and the direction that the lights 404, 406, 804, and 806 are pointed (as indicated by the lines 834a, 834d, 834b, and 834c, respectively). The angles 836a-d are chosen to uniformly illuminate a field of view that is wider than the angle between the two adjacent directions at which the camera 430 points (e.g., the lines of sight 808 and 810). In some embodiments, the angles 836a and 836d are 44 degrees (or 5% to 10% more), and the angles 836b and 836c are 22 degrees (or 5% to 10% more). The camera 430 has its lights oriented to provide a field of uniform illumination of about 100 degrees in the horizontal direction and 160 degrees in the vertical direction.

FIG. 9 is a flowchart of a method 900 of operating the hood 400 (having the lighting system for the camera 430). In a step 902, a determination is made of the angle (in some embodiments, 90 degrees) between each direction in which the camera 430 will capture an image. In a step 904, the lights 402, 404, 406, and 408 are arranged (and mounted) to uniformly illuminate an angle that is greater than the angle between the planned lines of sight. In some embodiments, the lights are permanently mounted in position according to the camera with which the hood 400 is intended to be used. In some embodiments, the servo motors automatically angle and position the lights to uniformly light the angle covered by an area of interest. In an optional step 906, the hood 400 is placed on the camera 430. In an optional step 908, the lights 404 and 408 are set to turn on while the lens system 432 is open. In some embodiments, in a step 908, the lights 404 and 408 are turned on and left on throughout the photographing of the image. In some embodiments, the lights are used as a flash.

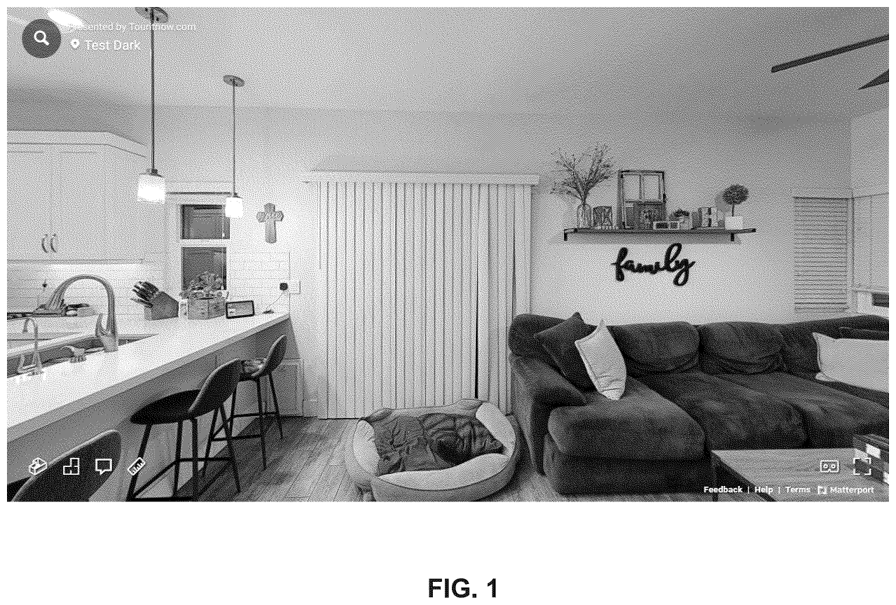

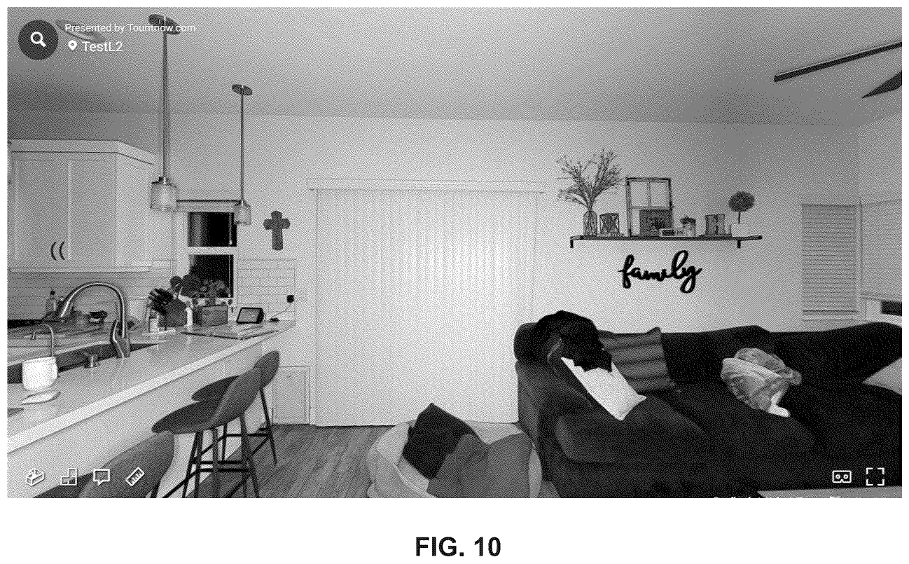

FIG. 10 illustrates an image of a room illuminated with the hood 400 having the lights facing in the same direction as the camera 430. The uniformity of the illumination and brightness of the illumination is similar to the illumination provided by the room's lights, without using as much power. One can distinguish between FIG. 1 and FIG. 10 by the illumination emitted from the ceiling lights. Specifically, in FIG. 1, the ceiling lights are brighter than in FIG. 10, because the ceiling lights of FIG. 1 are lit (providing the lighting of the room), and in FIG. 10 they are not. Other than whether the room lights appear on, the two images (FIG. 1 and FIG. 10) are essentially indistinguishable.

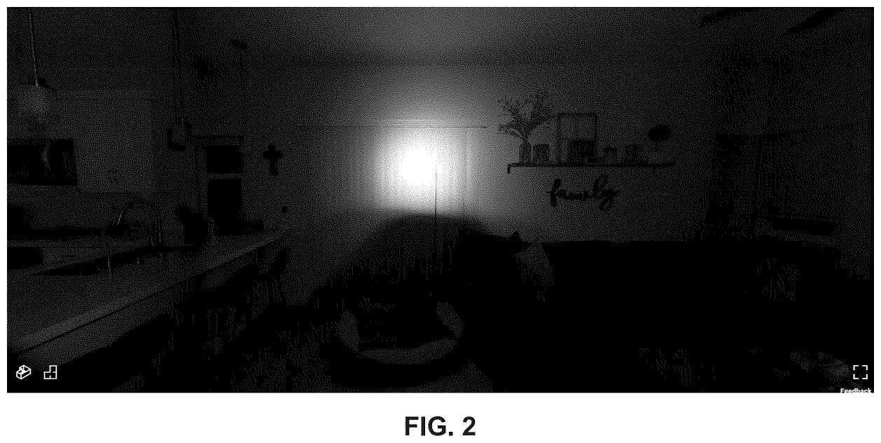

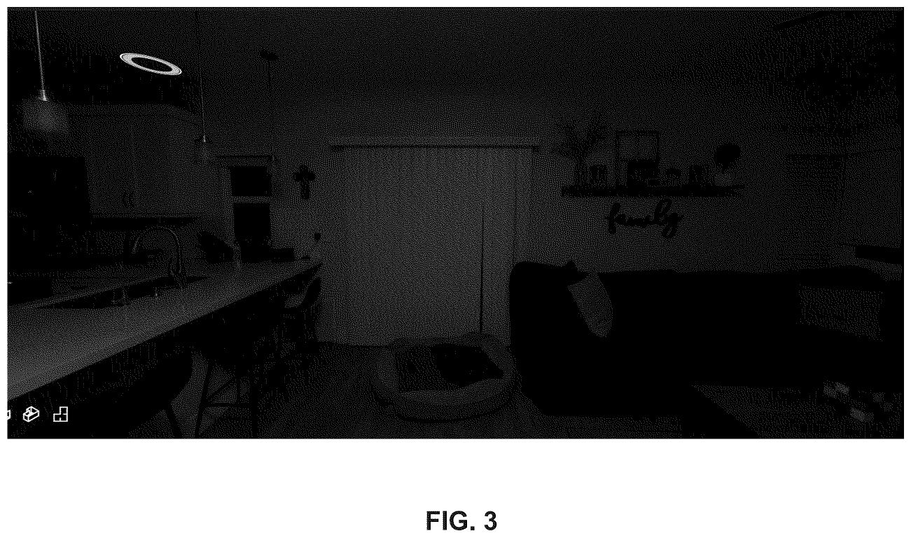

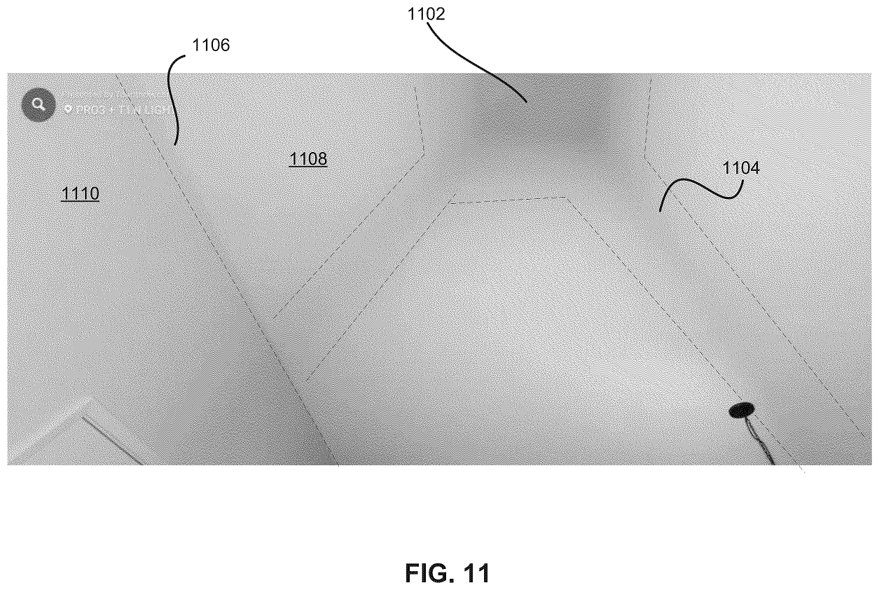

However, when piecing together panoramic images a shadow often appears at the place where the two images are combined. This can be problematic when an accurate image of a region is needed. For example, when photographing a burn sight, there may be no way of distinguishing between the shadow and scorch mark, which may lead to an inaccurate insurance estimate of the repairs that need to be performed. FIG. 11 illustrates an image formed by combining multiple images. At the seams where the images are combined, there are shadows 1102 and 1104. In FIG. 11 the shadows 1102 and 1104 have been surrounded by dashed lines to help identify the shadows 1102 and 1104. In contrast to the shadows 1102 and 1104, the shadow 1106 is the corner formed by the meeting of ceiling 1108 and wall 1110 and (in contrast to shadows 1102 and 1104) indicates the structure of the room. Despite the shadows, the illumination provided by the hood 400 is far better than that provided by a prior art light used for capturing the images of FIGS. 2 and 3. The shadows of FIG. 11 can be reduced by matching the illuminations of the frames at the region where the images are joined, by increasing the angle of the region that is uniformly illuminated.

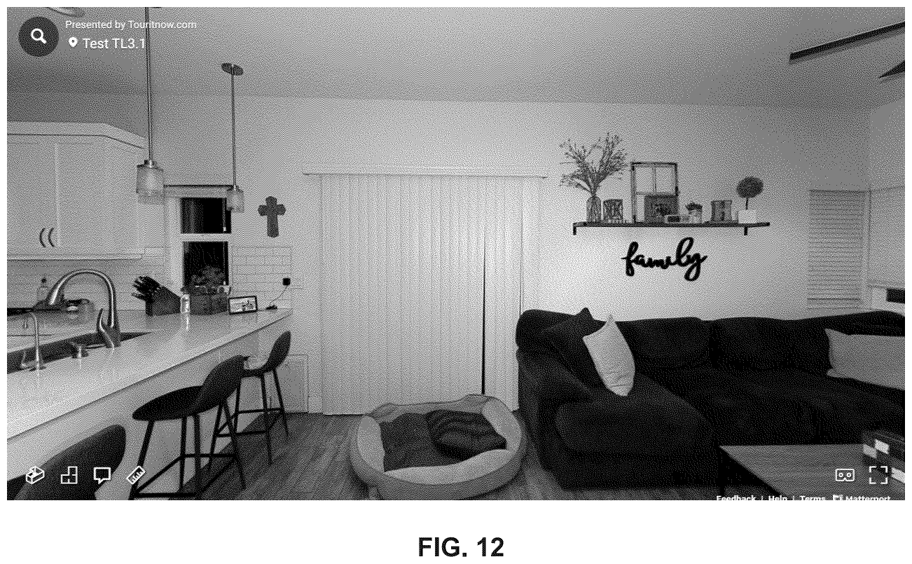

FIG. 12 illustrates a portion of an area of interest illuminated uniformly and brightly by the hood 400. The embodiment of the hood 400 includes a second pair of side lights angled at 22 degrees (in addition to the first pair of side lights angled at 44 degrees), which are closer to the lens the lights facing at 44 degrees. In some embodiments, the lights pointing at 44 degrees are LEDs that draw 6.5 watts, and the lights pointing at 22 degrees are 5-watt LEDs. In some embodiments, the LEDs use 12 to 14 volts. In a 12 ft by 12 ft room, the second pair of lights (pointing 22 degrees) increases the intensity of lighting by about 40% more than were there just one set of lights pointing at 44 degrees from the direction of the lights.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
a) a hood for a camera,
i. the hood being shaped to circumscribe a rectangular central region, the rectangular central region having an opening for a front of the camera to protrude into, while leaving a back of the camera protruding out of the rectangular region and allowing a lens on a front of the camera to receive light entering the rectangular central region,
ii. the hood including four troughs including two horizontal troughs connected to two vertical troughs to form one combined rectangular trough, each trough having an opening facing away from the trough, therein forming four openings for the four troughs;
b) four strips of lights, each of the four strips of lights being placed in one of the four troughs, the four strips facing the openings of the troughs;
the hood having a configuration such that when the camera is placed through the rectangular region, the four strips of lights are oriented to illuminate a region in front of the camera.

2. The system of claim 1, the camera being pivotally mounted, allowing the camera to pivot and capture images at different angles of pivot, the camera being set to capture a plurality of images at a series of equally spaced angles of pivot, the strips of lights uniformly illuminating a region to form a uniformly-lit-area, the uniformly-lit-area subtending an angle that is greater than a difference between two consecutive angles of the series.

3. The system of claim 2, the plurality of images including four image capture areas each associated with a different one of four lines of sight, the lines of sight being 90 degrees apart, each uniformly-lit-area subtending an angle that is 90 degrees or greater.

4. The method of claim 1, the two strips of lights in the two vertical troughs including two vertical strips of lights angled so that the two vertical strips of lights point in directions that are 44 degrees outward away from a direction that the camera points.

5. The method of claim 1, the two strips of lights in the two vertical troughs including two vertical strips of lights angled so that the two vertical strips of lights point in directions that are 22 degrees outward away from a direction that the camera points.

6. The method of claim 1, the two strips of lights in the two horizontal troughs including two horizontal strips of lights angled so that the two horizontal strips of lights point in directions that are 60 degrees outward away from a direction that the camera points.

7. The system of claim 1 further comprising: the hood having supports to which the strips of lights are mounted.

8. The system of claim 1, the hood further comprising air vents for cooling the strips of lights.

9. The system of claim 1, the hood further comprising a power source powering the four strips of lights.

10. The system of claim 1, the strips of lights comprising light emitting diodes.

11. The system of claim 10, the strips of lights further comprising one or more heat sinks backing the light emitting diodes.

12. The system of claim 1, the hood having a cutout that fits around a column of a tripod.

13. The system of claim 1, the hood including tabs attached to the walls of the hood upon which to attach the light strips.

14. The system of claim 1, the hood including tabs attached to the walls of the hood upon which to attach one or of the four light strips.

15. The system of claim 14, the hood including a fastener oriented to fasten the one or of the four light strips.

16. A system comprising:
a) a plurality of lights mounted around a lens of a camera,
i) the camera being set to capture a plurality of images and combine the image plurality of images into a combined image, each image of the plurality of images being associated with an image-capture-area, the image-capture-area being an area captured in the image that is included in the combined image;
ii) the plurality of lights being angled to create a uniformly-lit-area, the uniformly-lit-area being greater than a region that creates the image-capture-area.

17. A method comprising:
a) placing a hood on a camera,
i. the hood being placed to circumscribe a rectangular central region, the rectangular central region having an opening for the camera to protrude into, while leaving a back of the camera protruding out of the rectangular region and allowing a lens on a front of the camera to receive light entering the rectangular central region, the hood being placed with the camera protruding into the rectangular central region, the hood including four troughs including two horizontal troughs connected to two vertical troughs to form one combined rectangular trough, each trough having an opening facing away from the trough, therein forming four openings for the four troughs;
ii. the hood having four strips of lights placed in the four troughs, each of the four strips of lights being placed in one of the four troughs, the four strips facing the openings of the troughs,
iii. the placing of the hood on the camera including orienting the four strips of lights to illuminate a region towards which the lens of the camera faces.

18. The method of claim 17, the two strips in the two vertical strips being orientated at angles being 44 degrees outwards away from a direction that the camera points.

19. The method of claim 17, the two strips in the two horizontal strips being orientated at angles being 22 degrees outwards away from a direction that the camera points.

20. The method of claim 17, further comprising determining a plurality of angles at which to orient the four strips of lights based on a series of angles at which the camera is set to take pictures, and setting the plurality of angles of the lights based on the plurality of angles determined.
